(19) United States
(12) Patent Application Publication
(10) Pub. No.: US 2019/0115708 A1
(43) Pub. Date: Apr. 18, 2019

(54) PLASTIC PRODUCT PRODUCTION METHOD, CONNECTOR PRODUCTION METHOD, AND SENSOR PRODUCTION METHOD

(71) Applicant: NGK Spark Plug Co., LTD., Nagoya (JP)

(72) Inventor: Koichi IMAEDA, Konan (JP)

(73) Assignee: NGK Spark Plug Co., LTD., Nagoya (JP)

(21) Appl. No.: 16/118,030

(22) Filed: Aug. 30, 2018

(30) Foreign Application Priority Data
Oct. 18, 2017 (JP) 2017-201574
Jun. 13, 2018 (JP) 2018-112644

(51) Int. Cl. H01R 43/18; B23K 26/00; B23K 26/354

(52) U.S. Cl. CPC H01R 43/18; H01R 13/465; B23K 26/354; B23K 26/0006

(57) ABSTRACT

A method for producing a product with an information portion in which laser light is applied to a part of a surface of a plastic product so as to generate a foam portion exhibiting a color different from a color of the plastic product. The method comprises the steps of: forming an information portion that contains the color of the plastic product and the color of the foam portion; forming a recess at a pre-foam portion, which is to become the foam portion; and applying the laser light to the pre-foam portion in such a way that the foam portion does not to protrude from a rim of the recess.

This application claims the benefit of Japanese Patent Application No. 2017-201574, filed Oct. 18, 2017 and Japanese Patent Application No. 2018-11264, filed Jun. 13, 2018, both of which are incorporated herein by reference in their entirety.

### FIELD OF THE INVENTION

The present invention relates to a plastic product production method, a connector production method, and a sensor production method in which a binarized information portion such as a two-dimensional code is formed on a surface of a plastic product.

### BACKGROUND OF THE INVENTION

For example, there is an individual difference in detection sensitivity and the like among gas sensors for detecting the concentration of oxygen in exhaust gas from an internal combustion engine, and information about a sensitivity correction value needs to be transferred to an external device (a correction circuit, a controller, or an ECU) or the like for controlling gas sensors. Thus, a technology has been developed in which a two-dimensional code that stores information about a sensitivity correction value is burnt by means of laser light onto a surface of a gas-sensor-side plastic connector to be connected to an external device (e.g., see Japanese Unexamined Publication No. 2016-61596). In addition, process control in a manufacturing process or an assembling process or the like can also be performed by storing, in the two-dimensional code, management information or the like such as a lot or serial number.

In particular, direct part marking (DPM) in which a two-dimensional code or the like is not printed on a target surface but is directly marked thereon by means of laser light or the like has advantages that: the DPM uses no ink or no stamping material, and thus can be performed at low cost; and no printed sticker is pasted, and thus peeling of stickers does not occur. In the direct marking that uses laser light, the laser light is applied to a part of a surface of a plastic product so as to cause the light-applied portion of the plastic product to foam, and, by making use of a feature in which the foam portion exhibits a color different from the color of a base material of the plastic product (the color changes), a two-dimensional code (binarized information portion) formed by both colors is formed. Changing of the color of the laser-light-applied portion as a result of an additive (color-developing agent) for laser marking being mixed with the plastic product has also been performed.

### Problems to be Solved by the Invention

However, since the foam portion swells upward from the base material of the plastic product and thus the foam portion is easily scratched or shaved, a problem arises that the two-dimensional code becomes difficult to be read. In particular, since guarantee of the qualities of two-dimensional codes and the like have been recently required, it has become important to maintain a normal reading condition.

Thus, an object of the present invention is to provide a plastic product production method, a connector production method, and a sensor production method that enable inhibition of damage on an information portion formed on a surface of a plastic product directly by means of laser light.

### SUMMARY OF THE INVENTION

### Means for Solving the Problems

In order to solve the above-mentioned problem, the present invention discloses a method for producing a product with an information portion in which laser light is applied to a part of a surface of a plastic product so as to generate a foam portion exhibiting a color different from a color of the plastic product, thereby forming the information portion that contains the color of the plastic product and the color of the foam portion, the method comprising the steps of; forming a recess at least at a pre-foam portion that is to become the foam portion; and applying the laser light to the pre-foam portion in such a way that the foam portion does not protrude from a rim of the recess.

With this production method, the foam portion is formed so as not to protrude from the rim of the recess in the surface of the plastic product. Accordingly, the foam portion is inhibited from being scratched or shaved as a result of protruding to the surface of the plastic product, whereby damage on the information portion can be inhibited and reading of the information portion and the like can be prevented from becoming difficult.

In the recess-forming step, the recess may be formed by applying recess-forming laser light to the pre-foam portion of the plastic product.

By forming the recess through application of laser light, the recess can be accurately formed as compared to a case where the recess is formed through mechanical cutting or the like.

Since there is a difference in laser light energy between formation of the recess and formation of the foam portion in the recess, if these steps are performed in the same step (in a single stage), the foam portion is insufficiently formed so that it becomes difficult to form a clear information portion, or a shallow recess is formed so that the information portion is easily damaged. Thus, by performing formation of the recess and formation of the foam portion in separate steps (two stages), a clear information portion, damage on which is inhibited, is obtained.

In the production method according to the present invention, the same laser light may be used as the laser light and the recess-forming laser light, and an output of the recess-forming laser light may be made higher than an output of the laser light.

With this production method, since the same laser light is used as the laser light and the recess-forming laser light, production can be performed with a single laser device, and thus the equipment is simplified. In this case, since higher energy is required for forming the recess, the output of the recess-forming laser light is made higher than the output of the laser light used for forming the foam portion.

In the production method according to the present invention, the information portion may be a one-dimensional or two-dimensional code.

With this plastic product production method, damage on the one-dimensional or two-dimensional code can be inhibited and reading thereof and the like can be prevented from becoming difficult.

The present invention also discloses a method for producing a connector having a plastic cover, wherein the method for producing a product with an information portion is used to form the information portion on a surface of the cover.

The present invention also discloses a method for producing a sensor including a sensor body and a connector which connects the sensor body and an external device to each other and which has a plastic cover, wherein the method for producing a connector is used to form the information portion on a surface of the cover.

### Effects of the Invention

With this invention, damage on the information portion directly formed on the surface of the plastic product by means of the laser light can be inhibited.

### BRIEF DESCRIPTION OF THE DRAWINGS

These and other features and advantages of the present invention will become more readily appreciated when considered in connection with the following detailed description and appended drawings, wherein like designations denote like elements in the various views, and wherein:

FIG. 1 is a perspective view of a connector produced by a plastic product production method according to an embodiment of the present invention.

FIG. 2 is a schematic view showing a mode in which a sensor body and an external device are connected to the connector in FIG. 1.

FIGS. 3A, 3B, and 3C are views illustrating processes in the plastic product production method according to the embodiment of the present invention.

FIG. 4 is a perspective view showing a recess and a foam portion.

FIGS. 5A, 5B, and 5C are views illustrating processes in a plastic product production method according to another embodiment of the present invention.

FIGS. 6A, 6B, and 6C are views illustrating processes in a plastic product production method according to still another embodiment of the present invention.

### DETAILED DESCRIPTION OF THE INVENTION

### Modes for Carrying Out the Invention

Hereinafter, embodiments of the present invention will be described.

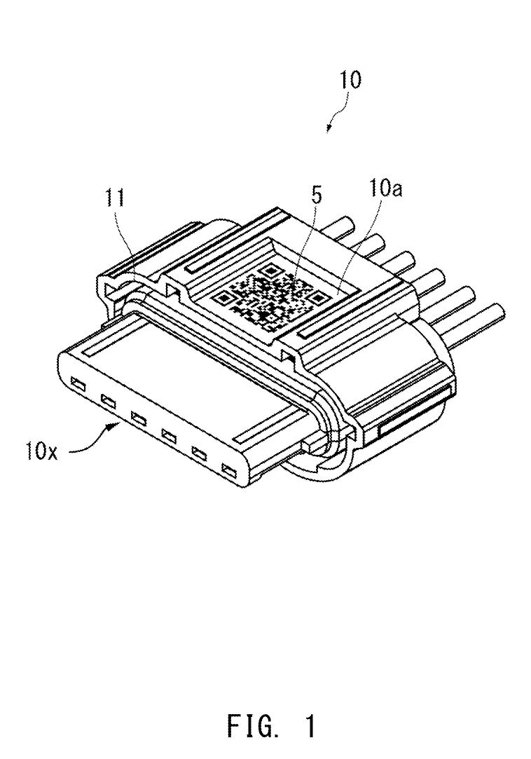

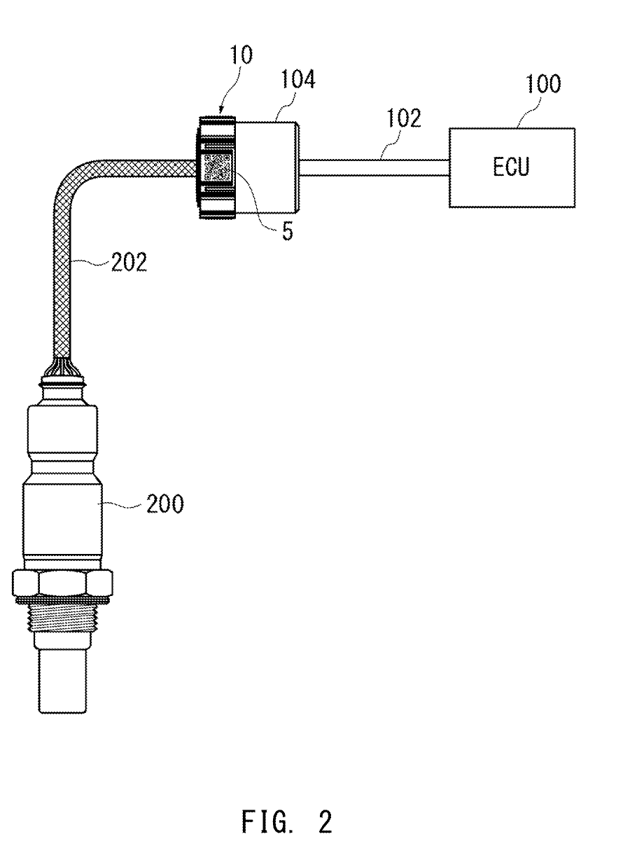

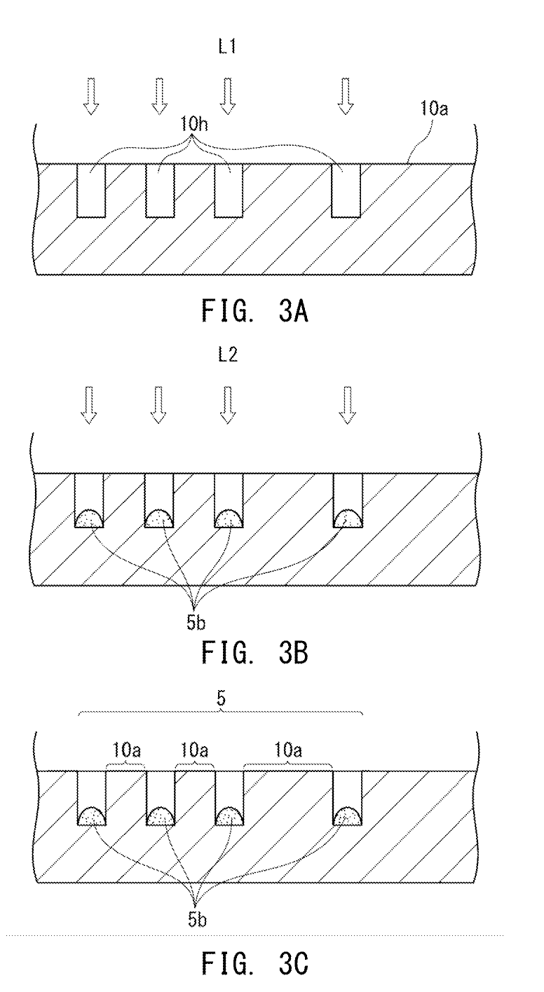

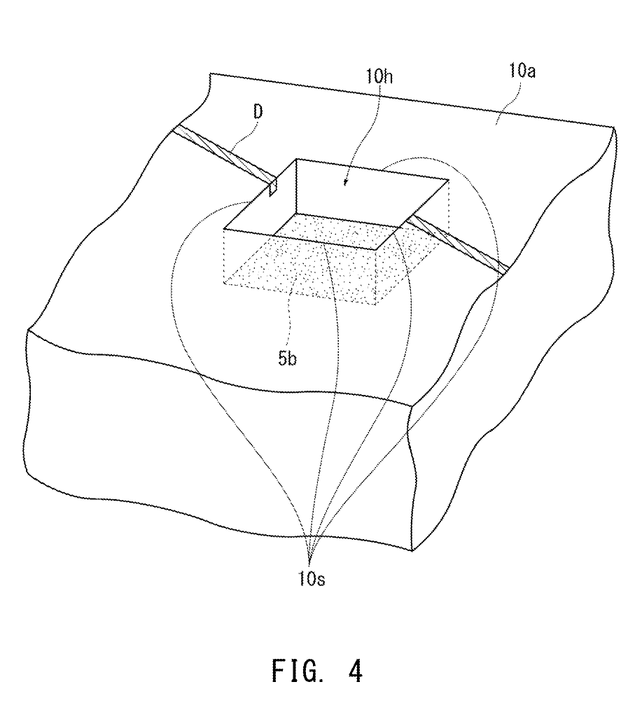

FIG. 1 is a perspective view of a plastic product (connector) 10 produced by a method according to an embodiment of the present invention. FIG. 2 is a schematic view showing a mode in which a sensor body 200 and an external device 100 are connected to the connector 10. FIGS. 3A, 3B, and 3C are views illustrating processes in the method according to the embodiment of the present invention. FIG. 4 is a perspective view showing a recess 10h and a foam portion 5b.

In FIG. 1, the connector 10 has: female terminals 10x to be electrically connected to the external device (ECU) 100 in FIG. 2; and a plastic cover 11 which integrally covers these terminals so as to form an outer surface, thereby serving as a housing. In the present embodiment, the housing portion of the connector 10 is made from polybutylene terephthalate. Direct marking of a two-dimensional code (information portion) 5 is performed on an upper surface of the connector 10 by means of laser light.

The two-dimensional code stores management information or the like such as a lot or serial number, or a sensitivity correction value for a detection sensitivity different among individual gas sensors 200, and these information items are read from the two-dimensional code by means of a scanner, and then transferred to the ECU 100 or used for performing process control in a manufacturing process or an assembling process or the like. On the basis of the sensitivity correction value, the ECU 100 calculates the concentration of a gas component such as the concentration of oxygen after acquiring a detection signal from the gas sensor 200. Examples of the gas sensor 200 include an oxygen sensor and a NOx sensor mounted to a vehicle.

As shown in FIG. 2, the connector 10 is connected to a wire cord 202 of the gas sensor 200. An ECU-side connector 104 connected to a wire cord 102 of the ECU 100 is electrically connected to the female terminals 10x of the connector 10. Accordingly, the gas sensor 200 is electrically connected to the external ECU 100.

Furthermore, a circuit which is not shown is provided to the ECU-side connector 104, and a signal detected by the gas sensor 200 is corrected in the circuit and transmitted to the ECU 100.

Next, a plastic product production method according to the embodiment of the present invention will be described with reference to FIGS. 3A, 3B, and 3C, and FIG. 4. The basis of the present embodiment is as follows: direct marking of the two-dimensional code (information portion) 5 is performed by means of laser light, that is, the laser light is applied to a part of a surface 10a of the connector 10 (cover 11) which is a plastic (polybutylene terephthalate) product so as to cause the polybutylene terephthalate (in a deep color) to foam so that a foam portion exhibiting a color (light color) different from that of the polybutylene terephthalate is formed, thereby forming a binarized information portion by the two colors, i.e., the base color of the polybutylene terephthalate and the color of the foam portion.

First, as shown in FIG. 3A, recess-forming laser light L1 is applied to foam-to-be-formed portions, of the connector 10 (cover 11), which are to become the foam portions 5b so that the recesses 10h are formed so as to be recessed from the surface 10a of the connector 10 (cover 11) (recess-forming step). In the example in FIGS. 3A, 3B, and 3C, the foam-to-be-formed portions and the recesses 10h are the same as each other. The individual recesses 10h are formed as a plurality of dots indicating a two-dimensional code so as to correspond to the foam portions 5b.

Next, as shown in FIG. 3B, laser light L2 is applied to each foam-to-be-formed portion (each recess 10h) so that the foam portion 5b is formed in the recess 10h (foam-portion-forming step). Specifically, the bottom surface of each recess 10h is flat, and, when the laser light L2 is applied to the bottom surface, polybutylene terephthalate foams and swells upward in the recess 10h, so that the foam portion 5b is formed.

Then, as shown in FIG. 3C, the two-dimensional code 5 which is an information portion is formed by the foam portion 5b (in a light color) formed in each recess 10h and by a base color (deep color) of the surface 10a which is located between the adjacent recesses 10h and to which the laser light L2 has not been applied.

Here, as shown in FIG. 4, the foam portion 5b is formed so as not to protrude from a rim 10s of the recess 10h to the surface 10a side. Accordingly, the foam portion 5b is inhibited from being scratched or shaved as a result of protruding to the surface 10a of the connector 10 (cover 11), whereby damage on the two-dimensional code 5 can be inhibited and reading thereof can be prevented from becoming difficult.

Since there is a difference in laser light energy between formation of the recess 10h and formation of the foam portion 5b in the recess 10h, if these steps are performed in the same step (in a single stage), the foam portion 5b is insufficiently formed so that it becomes difficult to form a clear two-dimensional code 5, or a shallow recess 10h is formed so that the foam portion 5b is easily damaged. Thus, by performing formation of the recess 10h and formation of the foam portion 5b in separate steps (two stages), a clear two-dimensional code 5, damage on which is inhibited, is obtained.

As shown in FIG. 4, even if a scratch D is formed on the surface 10a of the connector 10 (cover 11) forming the two-dimensional code 5, the scratch D is unlikely to reach the foam portion 5b in the recess 10h, and thus damage on the foam portion 5b can be inhibited, as described above. On the other hand, even if a scratch D is formed on the exposed surface 10a of the two-dimensional code 5, since the color of the surface 10a is unchanged from the base color of the plastic (polybutylene terephthalate) that is the base material before foaming (color change), and thus there is only small influence on the reading.

Examples of the method for forming the foam portion 5b such that the foam portion 5b does not protrude from the rim 10s of the recess 10h to the surface side include a method that involves adjustment of the depth of the recess 10h and energy for application of the laser light L2. The height of the foam portion 5b is preferably about ⅓ of the depth of the recess 10h.

However, if the recess 10h is excessively deep, it sometimes becomes difficult to read the foam portion 5b, and furthermore, with a part of the plastic material failing to sublime but being left on the wall surface of the recess 10h after application of the recess-forming laser light L1, it similarly sometimes becomes difficult to read the foam portion 5b. Although not limited, the depth of the recess 10h may be 40 μm or smaller, for example.

In the present embodiment, all the application positions of the laser lights L1 and L2 are the positions of the foam-to-be-formed portions. The laser lights L1 and L2 may be both applied so as to be scanned in a predetermined direction. By using the same laser light as the laser lights L1 and L2, production can be performed with a single laser device, and thus the equipment is simplified. In this case, since higher energy is required for forming the recess 10h, the output of the recess-forming laser light L1 is made higher than the output of the laser light L2.

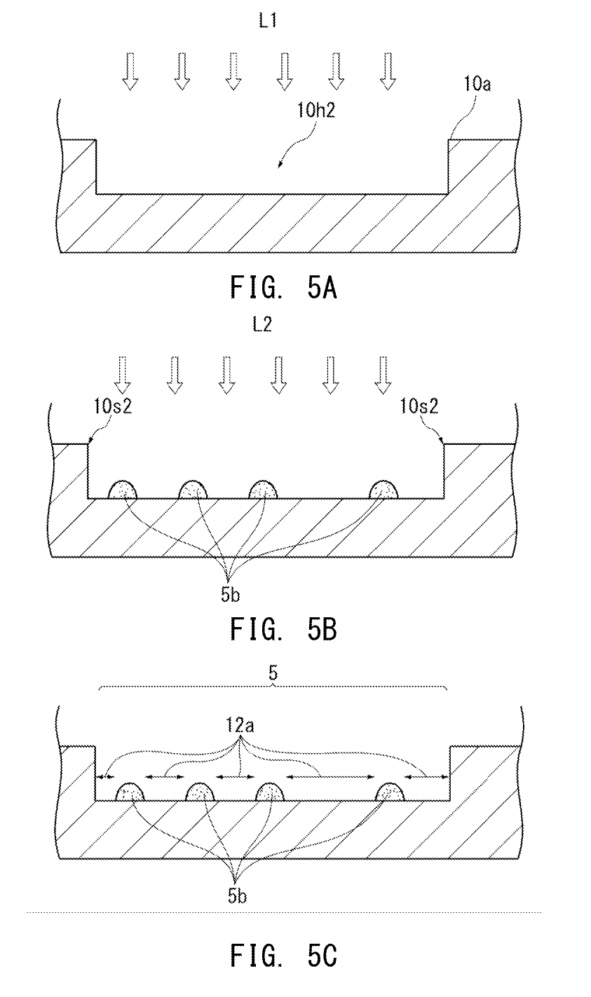

Moreover, as in the present embodiment (FIGS. 3A, 3B, and 3C), by performing setting such that all the application positions of the laser lights L1 and L2 are the positions of the foam-to-be-formed portions, i.e., such that the regions for forming therein the recesses 10h substantially coincide with the foam-to-be-formed portions, the foam portions 5b having dimensions approximately the same as those of the recesses 10h are formed in the recesses 10h, and thus foreign matter is less likely to enter therein, and each foam portion 5b is further inhibited from being scratched or shaved, as compared with the case of FIGS. 5A, 5B, and 5C described below.

It is needless to say that the present invention is not limited to the above-described embodiment, but is applicable to various modifications and equivalents encompassed in the idea and the scope of the present invention.

For example, as shown in FIG. 3B, the foam-to-be-formed portion coincides with the recess 10h in the above-mentioned embodiment, but, as shown in FIGS. 5A, 5B, and 5C, a recess 10h2 may be a region that includes the foam-to-be-formed portion and that is larger than the foam-to-be-formed portion.

In this case, first, as shown in FIG. 5A, the first laser light L1 is applied on a rectangular region that extends to the outer edge of the two-dimensional code 5, thereby forming one recess 10h2 recessed from the surface 10a of the connector 10 (cover 11) (recess-forming step). Next, as shown in FIG. 5B, the laser light L2 is applied to each foam-to-be-formed portion (each recess 10h) on the bottom surface of the recess 10h2, thereby forming a foam portion 5b in the recess 10h2 (foam-portion-forming step). It is needless to say that the foam portion 5b is formed so as not to protrude from a rim 10s2 of the recess 10h2 to the surface side.

Accordingly, as shown in FIG. 5C, the two-dimensional code 5 which is an information portion is formed by the foam portions 5b (in a light color) formed in the recess 10h2 and by a bottom surface 12a (in a deep color) of the recess 10h2 excluding the foam portions 5b.

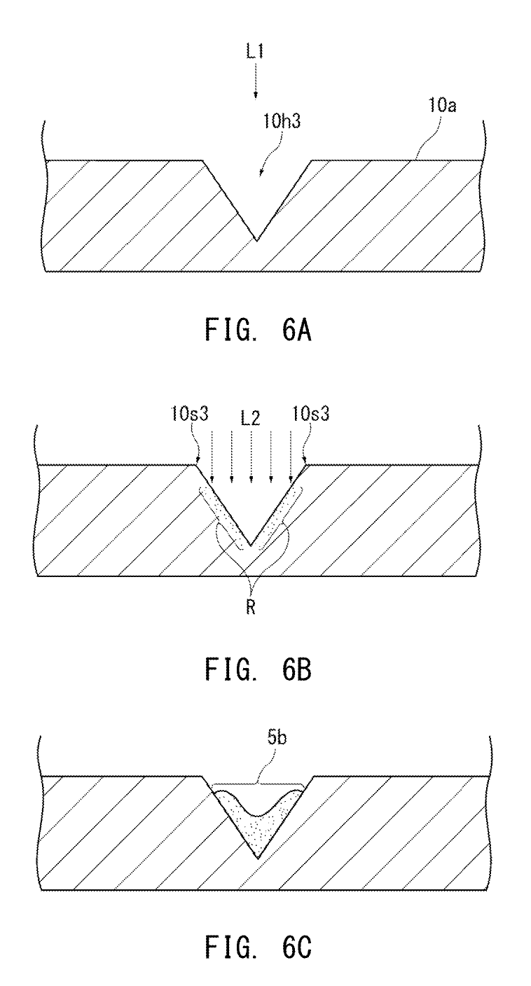

In the above-mentioned embodiment, a cross section in the depth direction of the recess has a rectangular shape (the bottom surface is flat), but the recess may have another shape as shown in FIGS. 6A, 6B, and 6C. For example, in the example in FIGS. 6A, 6B, and 6C, a cross section in the depth direction of a recess 10h3 has a V shape (FIG. 6A).

In this case, as shown in FIG. 6B, a part of a side wall between the valley of the recess 10h3 and a rim 10s3 thereof is set as a foam-to-be-formed portion R, and the laser light L2 is applied only to the foam-to-be-formed portion R.

Accordingly, the foam portion 5b is formed at the foam-to-be-formed portion R so as not to protrude from the rim 10s3 to the surface side.

Besides the V shape, the cross section in the depth direction of the recess may have a U shape.

In the above-mentioned embodiment, the laser light L1 is scanned to form all the recesses 10h in the recess-forming step, and thereafter, the laser light L2 is scanned to form the foam portions 5b in all the recesses 10h in the foam-portion-forming step. However, the following method may be employed, for example: one or a plurality of the recesses 10h are formed in the recess-forming step, and thereafter, the foam portions 5b are formed in the formed recesses 10h in the foam-portion-forming step, and then other recesses 10h are formed and the foam portions 5b are formed in the formed recesses 10h. That is, the recess-forming step and the foam-portion-forming step may be repeated a plurality of times.

In the above-mentioned embodiment, the color of the base material, of the plastic product, not having received the laser light L2 is a deep color, and the color of the foam portion 5b is a light color. However, the color of the foam portion 5b may be a deep color and the color of the base material of the plastic product may be a light color. In the latter case, for example, an additive (color-developing agent) that is darkened by application of laser light is mixed with the plastic product, or a transparent (translucent) material is used as the base material of the plastic product.

The difference in shade between the foam portion and the base material of the plastic product only has to be a difference such that, for example, images including both of them can be binarized (such that, when binarization is performed on the above-mentioned images with a predetermined threshold value, the brightnesses of both of them are each in a gradation represented with 1 bit (0 or 1)).

The information portion only has to be binarized, and may be in the form of, for example, character, symbol, pattern, mark, image, or the like, and is not particularly limited, but can be preferably applied to one-dimensional or two-dimensional codes.

In the above-mentioned embodiment, the laser light L1 is scanned to form the recesses in the recess-forming step, but the recesses may be formed by carving the surface of the connector with use of, for example, a carving machine instead of laser light, or may be formed by pressing a heated die against the surface of the connector. However, it is preferable to form recesses by means of laser light since, by doing so, laser light to be used in the foam step can be used, and thus the process is simplified, and the accuracy of forming the recesses is higher than those in other methods.

### DESCRIPTION OF REFERENCE NUMERALS

5: information portion (two-dimensional code)
5b: foam portion
10: plastic product (connector)
10a: surface
10h: recess
10s: rim of recess
11: cover
100: external device (ECU)
200: sensor body (gas sensor)
L1: recess-forming laser light
L2: laser light
R: foam-to-be-formed portion

1. A method for producing a product with an information portion, in which a laser light is applied to a part of a surface of a plastic product so as to generate a foam portion exhibiting a color different from a color of the plastic product, thereby forming the information portion that contains the color of the plastic product and the color of the foam portion, the method comprising the steps of;
forming a recess at a pre-foam portion that is to become the foam portion; and
applying the laser light to the pre-foam portion in such a way that the foam portion does not protrude from a rim of the recess.

2. The method according to claim 1, wherein,
in the recess-forming step, the recess is formed by applying a recess-forming laser light to the pre-foam portion of the plastic product.

3. The method according to claim 2, wherein
the same type of laser is used for both the laser light and the recess-forming laser light, and
an output of the recess-forming laser light is higher than an output of the laser light.

4. The method according to any claim 1, wherein
the information portion is a one-dimensional or two-dimensional code.

5. A method for producing a connector having a plastic cover, wherein
the method according to claim 1 is used to form the information portion on a surface of the cover.

6. A method for producing a sensor that includes;
a sensor body and
a connector which connects the sensor body and an external device and has a plastic cover, wherein
the method for producing the connector according to claim 5 is used to form the information portion on a surface of the cover.
